(19) United States
(12) Patent Application Publication
(10) Pub. No.: US 2017/0349046 A1
(43) Pub. Date: Dec. 7, 2017

(54) INFOTAINMENT SYSTEM, MEANS OF TRANSPORTATION, AND DEVICE FOR OPERATING AN INFOTAINMENT SYSTEM OF A MEANS OF TRANSPORTATION

(71) Applicant: VOLKSWAGEN AKTIENGESELLSCHAFT, Wolfsburg (DE)

(72) Inventors: Holger WILD, Berlin (DE); Nils KÖTTER, Braunschweig (DE)

(21) Appl. No.: 15/535,853

(22) PCT Filed: Oct. 7, 2015
(86) PCT No.: PCT/EP2015/073122

§ 371 Date: Jun. 14, 2017

(30) Foreign Application Priority Data
Dec. 22, 2014 (DE) 10 2014 226 760.9

(51) Int. Cl. B60K 37/06; G06F 3/044; G06F 3/042; G06F 3/0488; G06F 3/16

(52) U.S. Cl. CPC B60K 37/06; G06F 3/04883; G06F 3/165; G06F 3/0421; G06F 3/044; B60K 2350/2008; B60K 2350/1052; B60K 2350/1028; B60K 2350/2043; B60K 2350/352; B60K 2350/1012; G06F 2203/04104; B60K 2350/925

(57) ABSTRACT

A mode of transportation, an infotainment system, and a device for operating an infotainment system of a mode of transportation having a finger strip extending in a linear or curved manner for haptically guiding a finger of a user, a detection unit for detecting swipe gestures carried out on the finger strip, an analyzing unit for processing detected swipe gestures, and a linear light outlet extending at least approximately completely along the finger strip. The device acknowledges a user gesture by a light signal emitted from the light outlet in response to a user gesture detected by the detection unit.

### PRIORITY CLAIM

This patent application is a U.S. National Phase of International Patent Application No. PCT/EP2015/073122, filed 7 Oct. 2015, which claims priority to German Patent Application No. 10 2014 226 760.9, filed 22 Dec. 2014, the disclosures of which are incorporated herein by reference in their entirety.

### SUMMARY

Illustrative embodiments relate to a means of transportation, an infotainment system, and a device for operating an infotainment system of a means of transportation. Disclosed embodiments relate to a possibility for inputting stepless input values by means of swipe gestures without the need for the user to look at the user interface to carry out specific inputs.

### BRIEF DESCRIPTION OF THE DRAWINGS

Exemplary embodiments are described in detail in the following with reference to the accompanying drawings. In the drawings:

FIG. 1 shows a schematic overview of components of an exemplary embodiment of a disclosed means of transportation comprising an exemplary embodiment of a disclosed device;

FIG. 2 shows a perspective drawing of an exemplary embodiment of a disclosed device;

FIG. 3 shows a detailed view of a section of the exemplary embodiment shown in FIG. 2;

FIG. 4 shows a top view of an exemplary embodiment of a detection unit, which is used according to disclosed embodiments, comprising a plurality of capacitive antennas; and

FIG. 5 shows a basic diagram, illustrating an exemplary embodiment of a disclosed device, in which a display unit comprising a touch-sensitive surface provides a display panel, a detection unit, and a light outlet of a device.

### DETAILED DESCRIPTION OF THE DISCLOSED EMBODIMENTS

The trend in the cockpits of current means of transportation, in particular motor vehicles, is presently advancing toward a button-free design. Since conventional push/turn control knobs are also to be dispensed with in this case, whereby no substantial haptic feedback on user inputs takes place, there is a need for a user interface and an input element which can be well integrated into the appearance of a button-free cockpit yet nevertheless provides the customer with good orientation and visual feedback during the adjustment of important functions (such as, e.g., audio volume, scrolling in long lists, operating the climate controls, etc.).

DE 10 2012 008 681 A1 discloses a multifunctional operating device for a motor vehicle, in which a combined slider/touch-sensitive surface is provided for receiving swipe gestures and pressure-based inputs. The operating element is designed to be elongate or rectangular, wherein a raised edge projection is used for guiding the finger of the user. The operating element may be situated essentially vertically, laterally with respect to the screen display.

DE 10 2013 000 110 A1 discloses a control method and a control system in a vehicle, in the case of which buttons displayed on a first display panel change, in response to a touch-sensitive surface on a second display panel having been touched, in such a way that additional information belonging to the button is displayed on the first display panel. For this purpose, a touch-sensitive surface is provided for a capacitive interaction with an actuating object (e.g., a capacitive touchscreen).

DE 10 2008 048 825 A1 discloses a display and control system in a motor vehicle, comprising a user-adaptive representation, wherein a modification mode, in which all display objects are graphically represented at least partially in a portion of the display panel, can be activated via a user input. In this way, objects which were previously distributed over an entire display panel can be displayed in a portion which is located within reach of a user.

Proceeding from the aforementioned prior art, one problem addressed by the disclosed embodiments is that of integrating a comfortable input device for swipe gestures into the interior of a means of transportation in a visually beneficial way. Yet another problem addressed by the disclosed embodiments is that of designing feedback to a user of such a system to be intuitively understandable.

The problem identified above is solved according to the disclosed embodiments by a device for operating an infotainment system of a means of transportation. The device comprises a finger strip which extends in the shape of a line or a curve and is configured for haptically (longitudinally) guiding a finger of a user. In other words, a one-dimensional track for the finger of the user is predefined. Such a track has a concave and/or a convex (partial) structure transversely to its longitudinal direction, which is haptically detected by a user during a swipe gesture and can be utilized for orienting the finger on the finger strip. In addition, a detection unit is provided for detecting swipe gestures carried out on the finger strip. The detection unit can detect (capacitively, for example) a movement of human tissue carried out on the finger strip and can convert the movement into electrical signals. An evaluation unit is provided for processing detected swipe gestures (or signals generated by these swipe gestures) and can be designed as a programmable processor, a microcontroller, a nanocontroller, or the like. In addition, the device comprises a linear light outlet which extends at least approximately completely along the finger strip.

The light outlet can be a partially transparent plastic and/or glass body and/or sintered body, through which a lamp located behind the outlet can emit light in the direction of the user. The disclosed device can acknowledge the user gesture by means of a light signal emitted from the light outlet in response to a user gesture detected by means of the detection unit. For example, a function that has been started can be acknowledged by means of a light pattern assigned to the function. The light pattern can also have one or more colors which are uniquely assigned to the particular function that has been started. The actuation of the device can also be acknowledged by means of an output of an appropriate light signal independently of a successful start of a function assigned to the gesture. In the case of a swipe gesture, a shimmer (or a “glow” or “corona”) can also be generated around the finger or fingers, which moves along with the finger, whereby the user is informed about the way in which the device has detected his gesture. A user gesture can also be understood to even be an approach or contact by a finger or several fingers, wherein a chaser light or several chaser lights from the light outlet (e.g., starting at its edge or at its edges) is or are generated along in the direction of the finger or fingers, and so even inexperienced users receive an intuitively understandable signal indicating that they have just found or utilized an input interface.

The finger strip can be provided, for example, to be arranged horizontally. Therefore, a ledge or a support for a finger is formed in the vertical direction, whereby accelerations occurring in the vertical direction (e.g., during passage over a dip in the road or a pot hole) do not move the finger of the user out of an intended spatial zone in front of the finger strip. The operation of the device becomes intuitive when the finger strip is situated above and/or below a display panel in a means of transportation. In this way, the device or the finger strip provided according to the disclosed embodiments stands in a strong context of the display panels and is intuitively understood to be a component of a user interface. A pleasant and self-explanatory haptic sensation results in the case of an embodiment of the finger strip that is a groove- or trough-shaped longitudinal groove which, for example, follows a surface of a (flat or curved) screen.

The light outlet may be embedded into the finger strip, whereby the emitted light signal is associated strongly with the user gesture. In other words, the light outlet is also passed over during an operation of the finger strip according to the disclosed embodiments, and so the acknowledging light signal appears to be situated in the direct vicinity of and, in particular, also under the particular finger of the user.

One suitable possibility for implementing the acknowledging light signal consists of situating a light source behind the light outlet, which light source comprises individual lamps (e.g., light-emitting diodes, LEDs) which have a rapid response rate with respect to electrical signals controlling them. This provides for a precise output of light signals acknowledging the user gesture. A translucent (also colloquially referred to as “milky”) element can be provided to homogenize light emitted from the light outlet. In this way, the translucent element provides for a diffusion of the incident light in the direction of the user, whereby, on the one hand, the inhomogeneous light source is more visually attractive, while a precise positioning of the light signal is nevertheless possible.

The diversity of possible inputs becomes apparent to the user when the finger strip is delimited on both sides by visually and/or haptically delimited end regions to form keypads. For example, ridges, which the user can clearly feel, can be provided transversely to the longitudinal extension of the finger strip. Alternatively or additionally, grooves extending transversely to the longitudinal direction of the finger strip can be provided to visually and haptically delimit a swipe zone between the end regions with respect to the keypads. The keypads can also be operated in this way essentially without a visual detection of the device by the user. This increases road safety during the operation of the device according to the disclosed embodiments. For example, repeated tap inputs with respect to one of the keypads can be utilized to toggle a function assigned to the swipe zone. Possible functions that can be “tapped through” by means of the keypads are described further below in the present description. For example, a function selected for the swipe zone by means of a “long press” can also be assigned to the swipe zone for future operations. In this way, a function desired by the user can be permanently assigned to the swipe zone.

The light outlet may be configured for outputting a predefined other light color in the area of the keypads independently of a present light color in all other areas of the finger strip. The same applies for a light intensity. In other words, the areas of the light outlet in the end regions may be visually non-transparently delimited with respect to the swipe gesture zone of the finger strip. For example, three translucent components of the light outlet in the area of the visual and/or haptic delimitation can be interrupted by two opaque (also referred to as visually “non-transparent”) structures. For example, these visual interruptions can protrude from a surface of the finger strip in such a way that they provide for a haptic boundary of the end regions. Optionally, a visual cross luminance of light is at least avoided by way of the opaque structures not being superimposed by translucent elements in the direction of the user. A homogeneous surface can be nevertheless achieved by way of a completely transparent element forming the surface of the finger strip.

The detection unit can comprise a linear arrangement of a plurality of capacitive antennas which are situated next to each other in the main extension direction (longitudinal direction) of the finger strip in an area behind the finger strip. In other words, the individual capacitive antennas follow the linear shape of the finger strip, and so a large number of different input positions on the finger strip can be detected by the detection unit and signaled to the evaluation unit. As compared to capacitive surfaces of touch-sensitive screens, the individual capacitive antennas offer the benefit that they can be designed in a more flexible way with respect to sensitivity and range. For example, the detection unit can detect not only touches, but also approaches by a user without contact with the fingertip, and can signal these to the evaluation unit.

For example, the disclosed device can comprise a display unit including a touch-sensitive surface and can comprise a haptic barrier, which extends in the shape of a line or a curve, on the display unit. The barrier is used for delimiting a display panel of the display unit with respect to an edge region of the display unit, which edge region is provided to form a finger strip according to the disclosed embodiments. A segment of the touch-sensitive surface of the display unit situated in the area of the finger strip is therefore used as a detection unit for detecting press, tap, and swipe gestures of a user. Correspondingly, a segment of the display unit situated in the area of the finger strip can form the light outlet of the device. In other words, the light outlet is designed as a linear segment of a self-illuminating display unit. By way of the haptic barrier, the display unit can provide the display panel, on the one hand, and the detection unit and the light outlet of the device according to the disclosed embodiments, on the other hand, although the display unit can be produced as a one-piece element. This increases the stability of the device, reduces the number of components, eliminates assembly processes, and reduces production costs. In addition, one-piece components in vehicle manufacturing avoid problems of creaking, rattling, and undesirable ingress of dirt, whereby malfunctions are prevented.

Optionally, a proximity sensor system can also be provided, wherein the evaluation unit is configured for acknowledging a gesture, which has been detected by means of the proximity sensor system, by means of a light signal emitted from the light outlet. In other words, what takes place first is not the acknowledgement of a touch-based interaction of the user with the finger strip, but rather that a light signal is output already in response to an approach by the user to the finger strip, to inform the user that it is possible to carry out a touch-based input using the disclosed device and what such an interaction could look like. This can take place, for example, by means of light progressions and/or flashing patterns, whereby the user is prompted to input swipe or multi-touch gestures.

Optionally, the evaluation unit is configured for evaluating a first predefined gesture on the finger strip for adjusting a volume of a media playback. The first gesture can be, for example, a swipe gesture using one single finger. Alternatively or additionally, the evaluation unit is configured for evaluating a second predefined gesture on the finger strip for adjusting a volume of a voice output of the infotainment system. The second gesture can be, for example, a swipe gesture using precisely two fingers (multi-touch gestures). Alternatively or additionally, the evaluation unit is configured for evaluating a third predefined gesture on the finger strip for adjusting a volume of sound signs or acoustic warning tones. The third gesture can be, for example, a multi-touch swipe gesture carried out using precisely three fingers. An assignment between the aforementioned gestures and exemplary ranges of functions can be modified in any way without departing from the scope of the disclosed embodiments.

Depending on which type of gesture or which type of function started by the gesture is present, a message and/or an information icon can be output on a display unit of the device.

Alternatively or additionally, a light signal output via the light outlet can acknowledge the function and the type of detected gesture independently of each other. For example, the type of the gesture can be visualized or acknowledged by means of a position or several positions having greater light intensity. The utilized functions can be visualized by using different colors. For example, in the case of using a swipe gesture to operate a climate function, the light signal can be changed in the direction of blue or in the direction of red according to a decrease or an increase of a setpoint temperature, respectively. Provided the function is that of changing a volume, there can be a switch from a white light in the direction of red light when the volume is increased or, conversely, there can be a switch from a red light color to a white light when the volume is decreased. Of course, light of a first color can be applied approximately completely to the light outlet to visualize the type and manner of the function adjustment, while a second color is selected for light emitted in the area of the finger of the user, whereby the detected gesture is acknowledged (e.g., independently of an adjusted function).

The evaluation unit can be further configured for adjusting a light signal of a present setting of the ambient light of the means of transportation, which is emitted from the light outlet, in response to an expiration of a predefined time period after an end of a gesture detected by means of the detection unit. In other words, the light outlet as well as the lamp situated behind the light outlet can be utilized for supporting an ambient light concept, provided the finger strip according to the disclosed embodiments is not acutely used for receiving user gestures or for acknowledging user gestures. The predefined time period after which, subsequent to a user interaction, there is an automatic switch to the ambient light mode, can be, for example, a minimum time period which is whole-number multiples of one second in the range between one second and 10 seconds. In this way, the disclosed device is utilized in an even more diverse way to obtain an interior design which is visually pleasing as well as intuitive and comfortable to operate.

According to a second disclosed embodiment, an infotainment system for a means of transportation is proposed, which includes a device according to the embodiment mentioned first. In other words, the device is supplemented, in at least one disclosed embodiment, with ranges of functions such as, for example, music playback and/or a navigation function. Correspondingly, ranges of heating and climate control can also be adjusted and visualized via the disclosed device. The features and combinations of features resulting therefrom correspond to the embodiment mentioned first, and so reference is made to the comments provided above to avoid repetition.

According to a third disclosed embodiment, a means of transportation comprising an infotainment system according to the embodiment mentioned second or a device according to the embodiment mentioned first are proposed. The means of transportation can be, for example, a passenger car, a transporter, a truck, a motorcycle, or an aircraft and/or watercraft. Reference is also made to the comments provided above to avoid repetition with respect to the features and combinations of features of the means of transportation according to the disclosed embodiments.

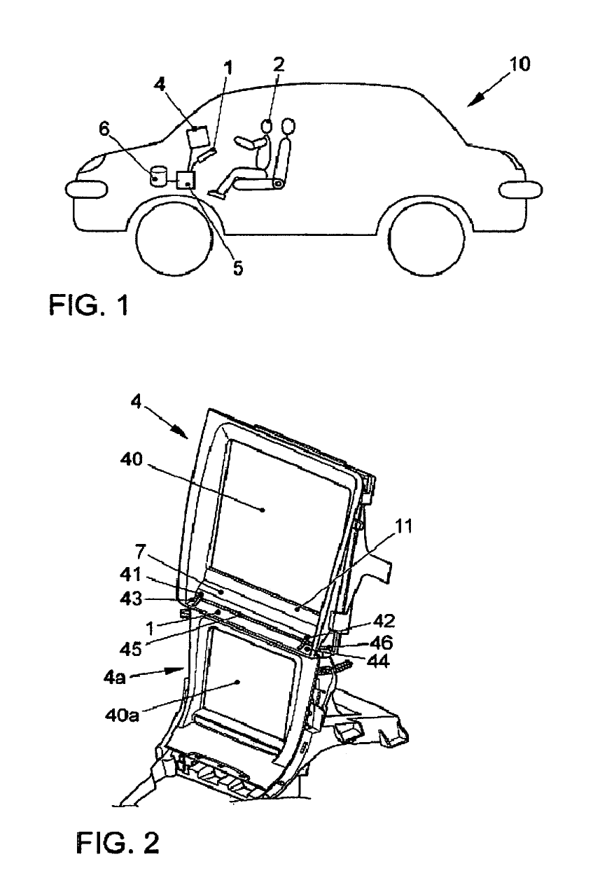

FIG. 1 shows a passenger car 10 as a means of transportation, in which a screen 4, as a display unit, is connected to an electronic control device 5, as the evaluation unit, for the purpose of information interchange. A finger strip 1 situated horizontally underneath the screen 4 is connected to the electronic control device 5 for the purpose of information interchange, to detect user gestures and visually acknowledge the user gestures by means of light signals. A data memory 6 contains predefined references for classifying the user gestures and is used for defining light signal patterns assigned to the classified user gestures. A user 2 extends his/her arm essentially horizontally to execute a swipe gesture on the finger strip 1. In the absence of a disclosed embodiment of the finger strip 1, vertical accelerations of the passenger car 10 would result in the user missing the finger strip 1, among other things. In addition, the user 2 would have to direct his/her attention to the finger strip 1 to squarely position his/her finger thereon. According to the disclosed embodiments, these actions can be dispensed with, since the finger strip 1 has a ledge-like structure for guiding the finger of the user 2.

FIG. 2 shows an exemplary embodiment of a disclosed device comprising two screens 4, 4a which are provided essentially one above the other for placement in a central console or instrument panel of a means of transportation. The display panels 40, 40a of the screens 4, 4a are sequentially separated, from top to bottom, by a ridge-shaped frame part 11 as a haptic barrier, an infrared LED strip 7 as the proximity sensor system, and a concave finger strip 1 into which a linear light outlet 45 is embedded, the outlet following the longitudinal extension direction of the finger strip 1. Distal regions 43, 44 of the finger strip 1 are delimited or made obvious, as buttons, with respect to a central swipe gesture region of the finger strip 1 by means of ridge structures 41, 42 oriented perpendicularly to the longitudinal extension direction. Adjoining the linear light outlet 45 is an optical waveguide 46 which extends essentially in the direction of travel and directs light originating from the direction of travel in the direction of the user to generate acknowledging light signals.

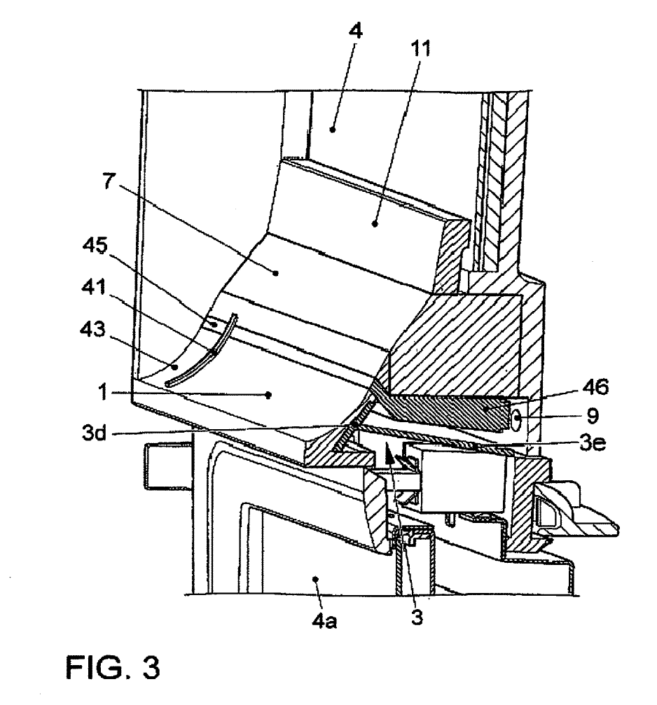

FIG. 3 shows a detailed view of the exemplary embodiment of a disclosed device, which is shown in FIG. 2. In this view, by way of example, an LED 9 is provided as a lamp of a light source on the optical waveguide 46 in the direction of travel, by means of which light source a narrow yet diffusely or non-sharply delimited area of the light outlet 45 shines in the light of the LED 9. Situated closely underneath the surface of the finger strip 1 is a support 3d of a capacitive detection unit 3, which support is mechanically and electrically connected to a circuit board 3e. The circuit board 3e supports electronic components (not shown) for operating the detection unit 3.

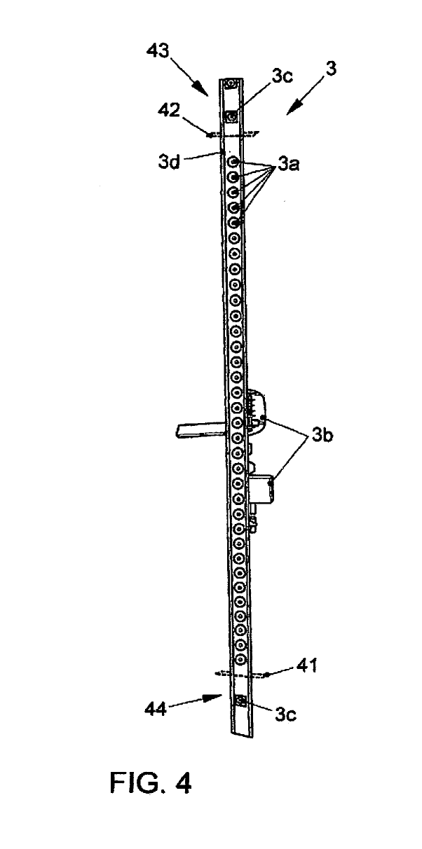

FIG. 4 shows an exemplary embodiment of a detection unit 3 of the type which was presented in FIG. 3. In the top view according to FIG. 4, linear capacitive antennas 3a situated next to each other are apparent on the support 3d, are each designed in the shape of a circular disk, and are situated equidistantly from each other. End regions 43, 44 are indicated by means of ridges 41, 42 depicted using dashed lines, each end region comprising a capacitive antenna 3c, which is designed in the shape of a square, for receiving press gestures and/or tap gestures and/or long press gestures. Electronic components 3b are situated on the circuit board (reference character 3e) in FIG. 3 and are provided for operating the antennas 3a, 3c.

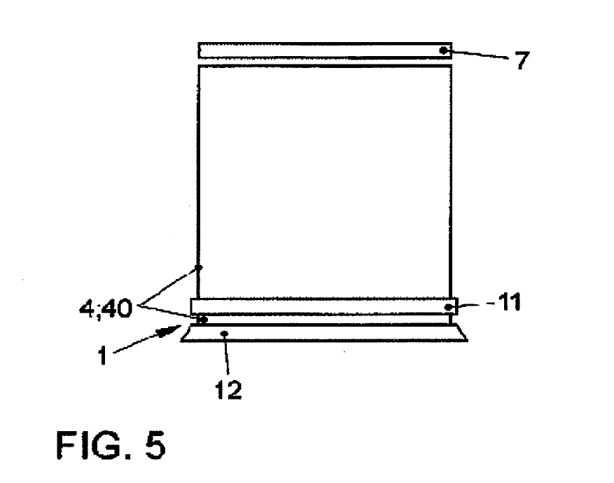

FIG. 5 shows a basic diagram of an alternative exemplary embodiment of a disclosed device for operating an infotainment system. Situated above a screen 4 comprising a display panel 40 is a proximity sensor system 7 for detecting an approach by a hand of a user to the device. A ridge 11 on the screen 4, which extends essentially horizontally, delimits a narrow surface area of the display area 40—which is assigned to a finger strip 1—from a main display area of the display panel 40. The screen 4 is designed as a touch screen (also referred to as a touch-sensitive display unit) of the type described in the prior art. To implement the disclosed device, however, a display area 40 situated above the ridge 11 is controlled entirely differently than an area situated underneath the ridge 11, which forms the detection unit and the light outlet of the device. In other words, a one-piece screen 4 that may be a touch screen is provided, the lower edge of which forms the detection unit and the light outlet of the disclosed device. The finger strip 1 is delimited toward the bottom by an essentially horizontal ledge 12 for the placement of a finger and for its guidance during execution of a swipe gesture.

Even if the disclosed embodiments have been described in detail with reference to the exemplary embodiments explained in combination with the attached figures of the drawing, modifications and combinations of features of the depicted exemplary embodiments are possible for a person skilled in the art without departing from the scope of the embodiments, the scope of protection of which is defined by the attached claims.

### LIST OF REFERENCE CHARACTERS

1 finger strip

2 user

3 detection unit

3a capacitive antennas

3b electronic components

3c capacitive antennas (touching zone)

3d support

3e circuit board of the detection unit

4, 4a screen

5 electronic control device

6 data memory

7 proximity sensor system

9 LED

10 passenger car

11 ridge/frame part

12 ledge

40, 4a display panel

1 41, 42 haptic limits

1 43, 44 end regions

45 light outlet

46 optical waveguide

1. A device for operating an infotainment system provided in a transportation vehicle, the device comprising:
a finger strip extending in a shape of a line or a curve for haptically guiding a finger of a user;
a detection unit for detecting swipe gestures carried out on the finger strip;
an evaluation unit for processing detected swipe gestures; and
a linear light outlet extending along the finger strip,
wherein the device is configured for acknowledging the user gesture by a light signal emitted from the light outlet in response to a user gesture detected by the detection unit.

2. The device of claim 1, wherein the finger strip is configured for horizontal placement above and/or below a display panel, in the transportation vehicle, and/or comprises a groove-shaped surface for guiding the finger, and/or a ledge for the placement of a finger.

3. The device of claim 1, wherein the light outlet is embedded into the finger strip.

4. The device of claim 1, wherein a light source is situated behind the light outlet, which comprises individual lamps wherein a translucent element is provided to homogenize light emitted from the light outlet.

5. The device of claim 1, wherein the finger strip is delimited on both sides by visually and/or haptically delimited end regions to form keypads.

6. The device of claim 5, wherein the light outlet is configured for outputting a predefined other light color in the area of the keypads independently of a light color in all other areas of the finger strip.

7. The device of claim 1, wherein the detection unit comprises a linear arrangement of a plurality of capacitive antennas situated next to each other in the main extension direction of the finger strip behind the finger strip.

8. The device of claim 1, further comprising:
a display unit including a touch-sensitive surface; and
a haptic barrier which extends in the shape of a line or a curve on the display unit for delimiting a display panel with respect to the finger strip, wherein
a segment of the touch-sensitive surface situated in the area of the finger strip forms the detection unit of the device, and
a segment of the display unit situated in the area of the finger strip forms the light outlet of the device.

9. The device of claim 1, further comprising a proximity sensor system, wherein the evaluation unit is configured for acknowledging a gesture, which has been detected by the proximity sensor system, by a light signal emitted from the light outlet.

10. The device of claim 1, wherein the evaluation unit is configured for evaluating
a first gesture on the finger strip to adjust a volume of a media playback, and/or
a second gesture on the finger strip to adjust a volume of a voice output of the infotainment system, and/or
a third gesture on the finger strip for adjusting a volume of sound signs.

11. The device of claim 10, wherein the evaluation unit is configured for acknowledging an evaluated first gesture and/or second gesture and/or third gesture of a user by a visual output of a first or second or third message, respectively, and/or an information icon on a display unit.

12. The device of claim 1, wherein the finger strip is configured for initiating multi-touch gestures, and the evaluation unit is configured for
acknowledging a gesture carried out using precisely one finger by a first light signal,
acknowledging a multi-touch gesture carried out using precisely two fingers by a second light signal and
acknowledging a multi-touch gesture carried out using precisely three fingers by a third light signal, all light signals being emitted from the light outlet,
wherein a position of the output of the light signal matches the particular gesture or multi-touch gesture.

13. The device of claim 1, wherein the evaluation unit is further configured for adjusting a light signal of a present setting of the ambient light of the transportation vehicle, which is emitted from the light outlet, in response to an expiration of a predefined time period after an end of a gesture detected by the detection unit.

14. An infotainment system provided in a transportation vehicle, the infotainment system comprising a device for operating the infotainment system, the device including a finger strip extending in a shape of a line or a curve for haptically guiding a finger of a user, a detection unit for detecting swipe gestures carried out on the finger strip, an evaluation unit for processing detected swipe gestures, and a linear light outlet extending along the finger strip,
wherein the device is configured for acknowledging the user gesture by a light signal emitted from the light outlet in response to a user gesture detected by the detection unit.

15. A transportation vehicle comprising the infotainment system of claim 14.
